(19) United States
(12) Patent Application Publication
(10) Pub. No.: US 2016/0136617 A1
(43) Pub. Date: May 19, 2016

(54) Synergized PGM Catalyst with Low PGM Loading and High Sulfur Resistance for Diesel Oxidation Application

(71) Applicants: Zahra Nazarpoor, Camarillo, CA (US); Stephen J. Golden, Santa Barbara, CA (US)

(72) Inventors: Zahra Nazarpoor, Camarillo, CA (US); Stephen J. Golden, Santa Barbara, CA (US)

(73) Assignee: Clean Diesel Technologies, Inc., Ventura, CA (US)

(21) Appl. No.: 14/543,564

(22) Filed: Nov. 17, 2014

(51) Int. Cl. B01J 23/40; B01J 35/00; B01J 23/34; B01J 23/44; B01J 23/42; B01D 53/94

(52) U.S. Cl. CPC B01J 23/40; B01J 23/42; B01D 53/9413; B01J 23/34; B01J 23/44; B01J 35/0053; B01D 53/944; B01D 2255/9022; B01D 2255/102

(57) ABSTRACT

Sulfur-resistant SPGM catalysts with significant oxidation capabilities are disclosed. Catalytic layers of SPGM samples may be prepared using incipient wetness and metallizing techniques to structure a washcoat layer of ZPGM material of YMnO₃ perovskite , and an overcoat layer including Pt/Pd composition on alumina-silica support oxide. Loading of PGM in OC layer is less than 5 g/ft³. A testing methodology for samples may be enabled including of DOC light-off, and soaking under isothermal DOC and sulfated DOC conditions to assess synergistic influence of adding ZPGM to PGM catalyst samples. Resistance to sulfur and catalytic stability may be observed under 5.2 gS/L condition to assess significant improvements in NO oxidation, HC conversion, and CO selectivity. Resistance to sulfur of disclosed SPGM catalyst may be compared with performance of an equivalent PGM control catalyst for DOC applications.

### CROSS-REFERENCE TO RELATED APPLICATIONS

N/A

### BACKGROUND

1. Field of the Disclosure

The present disclosure has general application in the field of diesel oxidation catalysis. More specifically, the present disclosure is particularly related to sulfur-resistant synergized PGM (SPGM) diesel oxidation catalysts structured with at least two catalytically active layers for utilization in the reduction of emissions from a plurality of diesel engine systems.

2. Background Information

Strict-compliance regulatory standards are continuously adopted worldwide to control emissions of nitrogen oxides (NOₓ), particulate matter (PM), carbon monoxide (CO), and hydrocarbons (HC) from various sources prior to exhaust gas discharges to the environment.

As known, a problem in diesel engines is that conventional diesel oxidation catalysts (DOCs) are vulnerable to sulfur poisoning, which occurs when some percent of SO₂ formed during combustion is oxidized to SO₃, which dissolves in the water vapor present to form sulfuric acid (H₂SO₄) vapor. Because sulfate particles account for a large portion of total particle matter and provide a relatively large surface area onto which HC species condense, this results in particle growth and increasing particle toxicity, which prevents the efficient functioning of certain types of catalysts and impedes the viability of emissions control technologies in diesel engine design.

Sulfur may also cause significant deactivation, even at very low concentrations, due to the formation of strong metal-sulfur bonds. During the emissions control process, sulfur chemisorbs onto and reacts with the active catalyst sites. The stable metal-adsorbate bonds can lead to non-selective side reactions, which modify the surface chemistry. Additionally, sulfur may impair the performance of the catalyst by reducing its activity either via competitive adsorption onto active sites, or by alloy formation with the active platinum group metals (PGM) sites. Current attempts to solve this problem have led manufacturers to produce catalyst systems in which the sulfur resistance of the catalysts is increased using high loading of PGM, which raises up the cost of the catalyst because PGMs are scarce, with small market circulation volume, constant fluctuations in price, and constant risk to stable supply, amongst others.

A need may exist for DOC systems including low PGM loading to achieve similar or improved performance and sulfur resistant, as compared to current DOC systems. Said catalyst systems may face the need of upgrading their resistance to catalytic poisons, such as sulfur, because the surface of metallic nano-particles in the catalytic centers may show affinity to catalytic poisons or other non-desirable chemical species. Such catalytic poisons or other non-desirable chemical species when adsorbed may block the adsorption of the target species of the catalyst, causing a serious suppression of the desired reactions. This suppression of reactions may take place even with overheating of the catalyst materials at regular intervals, causing thermal desorption of catalytic poisons from the catalytic center surface to reactivate the catalytic function. The problems faced by PGM catalyst systems may be addressed by using alternative materials which may be combined as active catalyst phases.

Therefore, as emissions regulations become more stringent, there is significant interest in developing DOCs with improved properties for effective utilization, and particularly, with improved activity and sulfur poisoning stability. The increasing need for new compositions and catalyst structures may include low loading of PGM material compositions in combination with Zero-PGM (ZPGM) materials in SPGM catalyst systems, exhibiting a synergistic behavior in yielding enhanced catalyst activity and resistant to sulfur poisoning under diesel oxidation condition, and which may be cost-effectively manufactured.

### SUMMARY

The present disclosure may provide a 2-layer structured synergized PGM (SPGM) catalysts for diesel oxidation catalyst (DOC) applications.

It is an object of the present disclosure to disclose SPGM catalyst systems having a high catalytic activity and resistance to sulfur poisoning when 5 g/ft³ PGM active components are synergized with Zero-PGM (ZPGM) catalyst compositions including a perovskite structure in a separate catalytic layer. The disclosed 2-layer SPGM catalysts may additionally provide catalyst systems of significantly high sulfur resistance.

According to embodiments in present disclosure, SPGM DOC systems may be configured to include at least a washcoat (WC) layer of ZPGM material compositions deposited on a plurality of support oxides of selected base metal loadings. In present disclosure, the WC layer may be formed using an YMnO₃ perovskite structure on doped ZrO₂ support oxide. The incipient wetness (IW) technique may be used to produce YMnO₃ perovskite/doped ZrO₂ powder, which is subsequently milled with water and coated as WC layer on a suitable substrate, followed by calcination.

A second layer of the SPGM DOC system may be configured as an overcoat (OC) layer in which a plurality of PGM material compositions on support oxides may be employed. In the present disclosure, the OC layer may be formed using a support oxide of alumina-silica metalized to a low loading PGM solution of platinum (Pt) and palladium (Pd) nitrates, then deposited onto the WC layer, and subsequently calcined.

In another aspect of present disclosure, the disclosed 2-layer SPGM catalysts for DOC application may be subjected to a DOC/sulfur test methodology to assess/verify significant NO oxidation activity and resistance to sulfur poisoning. DOC light-off tests may be performed to confirm synergistic effects of ZPGM catalytically active materials in the layered SPGM configuration. The sulfur resistance and NO oxidation of disclosed SPGM catalyst samples may be confirmed under a variety of DOC conditions at space velocity (SV) of about 54,000 h⁻¹ and according to a plurality of steps in the test methodology.

In this embodiment, the combined catalytic properties of the layers in SPGM catalyst system provide more efficiency toward NO oxidation and more stability against sulfur poisoning. Additionally, the perovskite catalyst compositions assist in accommodating the sulfur species, and make low loading PGM more available for NO oxidation, therefore disclosed SPGM formulations may be optimized to minimize deactivation of PGM catalyst material by sulfur poisons.

Numerous other aspects, features, and benefits of the present disclosure may be made apparent from the following detailed description taken together with the drawing figures, which may illustrate the embodiments of the present disclosure, incorporated here for reference.

### BRIEF DESCRIPTION OF THE DRAWINGS

The present disclosure can be better understood by referring to the following figures. The components in the figures are not necessarily to scale, emphasis instead being place upon illustrating the principles of the disclosure. In the figures, reference numerals designate corresponding parts throughout the different views.

FIG. 1 depicts a catalyst structure for 2-layer SPGM catalyst samples including a supported perovskite in washcoat layer as ZPGM catalyst and including an overcoat layer of PGM catalyst with low loading, according to an embodiment.

FIG. 2 shows a diagram of DOC test methodology employing a standard gas stream composition under DOC light-off (LO), soaking at isothermal DOC condition and sulfated DOC condition at a plurality of time periods to assess 2-layer SPGM catalyst samples activity and resistance to sulfur, at about 340° C. and space velocity (SV) of about 54,000 h⁻¹, according to an embodiment.

FIG. 3 reveals NO conversion LO for SPGM catalyst samples tested according to DOC test methodology employing a standard gas stream composition under DOC LO, soaking at isothermal DOC condition and sulfated DOC condition for 2.6 gS/L (grams sulfur per liter) and 5.2 gS/L, at about 340° C. and SV of about 54,000 h⁻¹, according to an embodiment.

FIG. 4 shows HC conversion LO for SPGM catalyst samples tested according to DOC test methodology employing a standard gas stream composition under DOC LO, soaking at isothermal DOC condition and sulfated DOC condition for 2.6 gS/L and 5.2 gS/L, at about 340° C. and SV of about 54,000 h⁻¹, according to an embodiment.

FIG. 5 represents NO, CO and THC conversion stability for SPGM catalyst samples tested according to DOC test methodology employing 5.2 gS/L, at about 340° C. and SV of about 54,000 h⁻¹, according to an embodiment.

FIG. 6 shows NO LO curves comparison of SPGM catalyst sample versus an equivalent PGM catalyst, under DOC test methodology before sulfation, employing a standard gas stream composition at SV of about 54,000 h⁻¹, according to an embodiment.

FIG. 7 depicts NO conversion stability comparison for SPGM catalyst versus an equivalent PGM catalyst, under isothermal sulfated DOC condition at sulfur concentration of 5.2 gS/L, at about 340° C. and SV of about 54,000 h⁻¹, according to an embodiment.

### DETAILED DESCRIPTION

The present disclosure is here described in detail with reference to embodiments illustrated in the drawings, which form a part here. Other embodiments may be used and/or other changes may be made without departing from the spirit or scope of the present disclosure. The illustrative embodiments described in the detailed description are not meant to be limiting of the subject matter presented here.

### Definitions

As used here, the following terms may have the following definitions:

“Catalyst” refers to one or more materials that may be of use in the conversion of one or more other materials.

“Washcoat” refers to at least one coating including at least one oxide solid that may be deposited on a substrate.

“Substrate” refers to any material of any shape or configuration that yields a sufficient surface area for depositing a washcoat and/or overcoat.

“Overcoat” refers to at least one coating that may be deposited on at least one washcoat or impregnation layer.

“Support oxide” refers to porous solid oxides, typically mixed metal oxides, which are used to provide a high surface area which aids in oxygen distribution and exposure of catalysts to reactants such as NOₓ, CO, and hydrocarbons.

“Catalyst system” refers to any system including a catalyst, such as a Platinum Group Metal (PGM) catalyst, or a Zero-PGM (ZPGM) catalyst a system, of at least two layers including at least one substrate, a washcoat, and/or an overcoat.

“Platinum group metals (PGM)” refers to platinum, palladium, ruthenium, iridium, osmium, and rhodium.

“Zero PGM (ZPGM) catalyst” refers to a catalyst completely or substantially free of platinum group metals.

“Synergized PGM (SPGM) catalyst” refers to a PGM catalyst system which is synergized by a non-PGM group metal compound under different configuration.

“Diesel oxidation catalyst (DOC)” refers to a device which utilizes a chemical process in order to break down pollutants from a diesel engine or lean burn gasoline engine in the exhaust stream, turning them into less harmful components.

“Perovskite” refers to a ZPGM catalyst, having ABO₃ structure of material which may be formed by partially substituting element “A” and “B” base metals with suitable non-platinum group metals.

“Incipient wetness (IW)” refers to the process of adding solution of catalytic material to a dry support oxide powder until all pore volume of support oxide is filled out with solution and mixture goes slightly near saturation point.

“Metallizing” refers to the process of coating metal on the surface of metallic or non-metallic objects.

“Conversion” refers to the chemical alteration of at least one material into one or more other materials.

“Poisoning or catalyst poisoning” refers to the inactivation of a catalyst by virtue of its exposure to lead, phosphorus, or sulfur in an engine exhaust.

“T₅₀” refers to the temperature at which 50% of a material is converted.

### Description of the Drawings

Embodiments of the present disclosure may use synergized PGM (SPGM) catalysts to enhance performance and sulfur resistance in diesel engine applications. The present disclosure is directed to a diesel oxidation catalyst (DOC) system configuration of a 2-layer SPGM catalyst including a washcoat layer of Zero-PGM (ZPGM) catalyst and an overcoat layer of low loading PGM catalyst to improve the conversion of species of NOₓ, HC, and CO from the diesel engine, and to confirm that disclosed SPGM formulations may lead into the development of sulfur resistant DOC.

Configuration, material composition, and preparation of SPGM catalyst systems

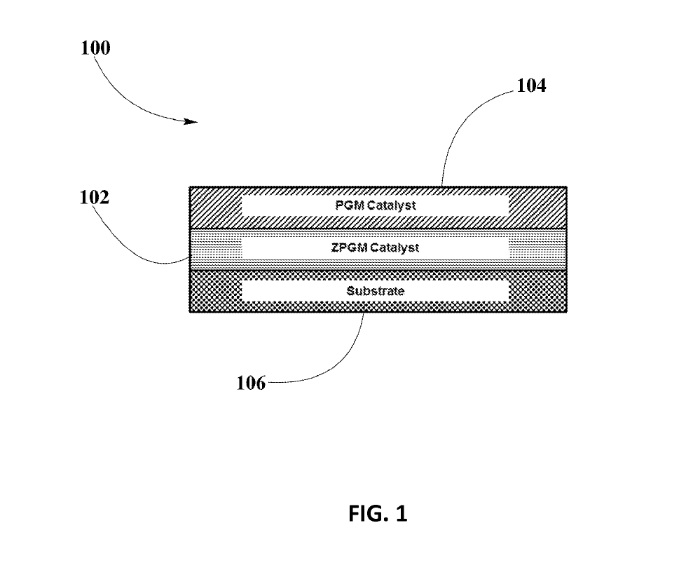

FIG. 1 depicts catalyst structure 100 for 2-layer SPGM catalyst samples including at least a washcoat (WC) layer 102 of ZPGM catalyst deposited on suitable substrate 106 and including an overcoat (OC) layer 104 of PGM catalyst deposited onto WC layer 102, according to an embodiment.

According to embodiments in present disclosure, 2-layer SPGM catalyst samples may be prepared including a WC layer 102 of material composed of a perovskite structure on a support oxide and deposited on suitable substrate 106. OC layer 104 may be prepared including one or more PGM material compositions on support oxide.

Materials suitable to form perovskites may include, but are not limited to, silver (Ag), manganese (Mn), yttrium (Y), lanthanum (La), cerium (Ce), iron (Fe), praseodymium (Pr), neodymium (Nd), strontium (Sr), cadmium (Cd), cobalt (Co), scandium (Sc), copper (Cu), and niobium (Nb). Suitable support oxides that may be used in WC and OC layers may include zirconia (ZrO₂), any doped ZrO₂ including doping such as lanthanide group metals, niobium pentoxide, niobium-zirconia, alumina type support oxide, titanium dioxide, tin oxide, zeolite, silicon dioxide, or mixtures thereof, amongst others. PGM material compositions may include platinum, palladium, ruthenium, iridium, and rhodium, either by themselves, or combinations thereof of different loadings.

In the present disclosure, ZPGM catalyst for WC layer 102 preferably includes YMnO₃ perovskite structure on doped ZrO₂ support oxide with a suitable loading of about 130 g/L.

In one embodiment, preparation of WC layer 102 includes preparing a Y-Mn solution by mixing the appropriate amount of Y nitrate solution and Mn nitrate solution with water to make a solution at the appropriate molar ratio. In the present disclosure a Y:Mn ratio of 1:1 is preferably used. In this embodiment, the Y-Mn solution is added to doped ZrO₂ powder by IW technique. Subsequently, this mixture powder is dried and calcined at about 750° C. for about 5 hours. The calcined mixture powder is then ground to fine grain for creating YMnO₃/doped ZrO₂ powder. Subsequently, YMnO₃/doped ZrO₂ powder is milled with water separately to make slurry, and then coated on suitable substrate 106 for calcination at about 750° C. for about 5 hours to form WC layer 102.

In this embodiment, the PGM catalyst for OC layer 104 includes a PGM solution of platinum (Pt) and palladium (Pd) nitrates on alumina-silica support oxide (Al203-5%SiO₂) with suitable loading of about 110 g/L.

The preparation of OC layer 104 includes milling Al203-5%SiO₂ support oxide into aqueous slurry. Further to this, the support oxide slurry may be metallized by a solution of Pt and Pd nitrates with a loading within 5 g/ft3, preferably about 4.5 g/ft3 of Pt and about 0.25 g/ft³ of Pd. Subsequently, OC layer 104 is deposited onto WC layer 102 and calcined at about 550° C. for about 4 hours.

DOC/sulfur test methodology

A DOC/sulfur test methodology may be applied to SPGM catalyst systems as described in FIG. 1. In one embodiment, the test methodology provides confirmation that the disclosed catalyst systems, including a WC layer of ZPGM (YMnO₃ perovskite structure) catalyst with an OC layer of PGM catalyst for DOC applications, have desirable and significant properties. Further to this embodiment, the SPGM catalyst samples in the present disclosure may confirm that SPGM catalysts prepared with low amount of PGM added to ZPGM catalyst materials are capable of providing significant improvements in catalytic activity and sulfur resistance.

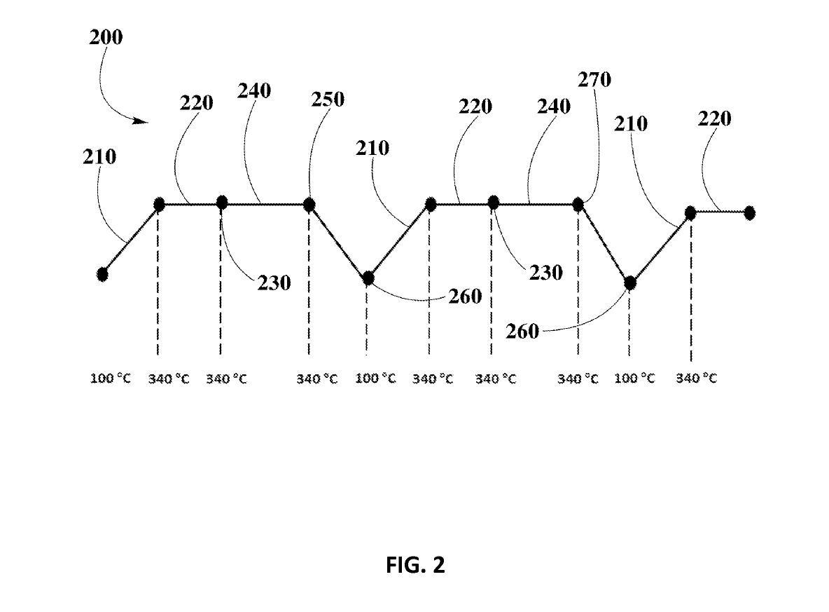

FIG. 2 shows a diagram of DOC test methodology 200. In FIG. 2, DOC test methodology 200 employs a standard gas stream composition administered throughout the following steps: DOC light-off (LO), soaking at isothermal DOC condition, and soaking at isothermal sulfated DOC condition. In this embodiment, DOC test methodology 200 steps are enabled during different time periods selected to assess the catalytic activity and resistance to sulfur of the SPGM catalyst samples. Steps in DOC test methodology 200 are implemented at an isothermal temperature of about 340° C. and space velocity (SV) of about 54,000 h⁻¹.

DOC test methodology 200 may start with DOC LO test 210, that is performed employing a flow reactor with flowing DOC gas composition of about 100 ppm of NO, about 1,500 ppm of CO, about 4% of CO₂, about 4% of H₂O, about 14% of O₂, and about 430 ppmC1 of mixed hydrocarbon, while temperature increases from 100° C. to 340° C., at SV of about 54,000 ⁻¹. Subsequently, at about 340° C., isothermal soaking under DOC condition 220 may be enabled for about one hour to stabilize catalyst performance at 340° C. At the end of this time period, at point 230, testing under soaking at isothermal sulfated DOC condition 240 may start by adding a concentration of about 3 ppm of SO₂ to the gas stream for about 12 hours. At the end of this time period, at point 250, sulfation may be stopped, when the amount of SO₂ passed to catalyst is about 2.6 gS/L of substrate. Subsequently, the flowing gas stream is allowed to cool down to about 100° C., at point 260. DOC test methodology 200 may then continue by performing another cycle of test steps including DOC LO test 210, isothermal soaking under DOC condition 220 for about one hour, and sulfated DOC condition 240, flowing about 3 ppm of SO₂ for 12 hours in the gas stream, until reaching a total SO₂ passed to catalyst of about 5.2 gS/L of substrate at point 270, when sulfation of the gas stream may be stopped. Thus, catalyst activity of the SPGM catalyst sample may be determined by another DOC LO and soaking after a total of about 24 hours sulfation soaking. NO conversion and sulfur resistance may be compared at the end of test for all the DOC conditions, i.e., before and after sulfation, in the test methodology.

Catalyst activity of SPGM samples under DOC and sulfation conditions

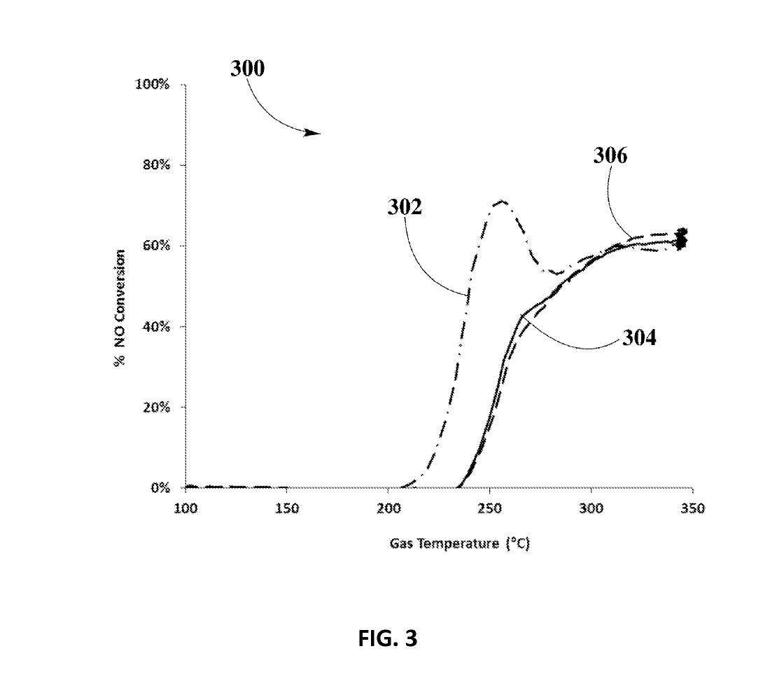

FIG. 3 reveals NO conversion comparison 300 for SPGM catalyst samples tested according to DOC test methodology 200 and employing a standard gas stream composition under DOC LO test 210, isothermal soaking under DOC condition 220, and under sulfated DOC condition 240 for 2.6 gS/L and 5.2 gS/L, at about 340° C. and SV of about 54,000 h⁻¹, according to an embodiment.

As can be seen in FIG. 3, conversion curve 302 represent % NO conversion LO before sulfation, under DOC LO test 210 and isothermal soaking under DOC condition 220; conversion curve 304 depicts % NO conversion LO after sulfation under sulfated DOC condition 240 for about 12 hours, SO₂ concentration of about 2.6 gS/L; and conversion curve 306 shows % NO conversion after sulfation under sulfated DOC condition 240 for a second period of about 12 hours, (a total sulfation time of about 24 hours), with SO₂ concentration of about 5.2 gS/L.

It may be observed that before sulfation, NO oxidation in conversion curve 302 reaches a maximum NO conversion of about 71.2% at 256° C. After sulfation with 2.6 gS/L and 5.2 gS/L rate, in conversion curve 304 and conversion curve 306, a decrease in NO conversion is observed in lower temperature range. However, at a higher range of temperature from about 290° C. to about 340° C., NO conversion of the SPGM catalyst is similar before and after sulfation. NO oxidation LO shows significant sulfur resistance of SPGM catalyst as shown by constant NO conversion LO after sulfation with 2.6 gS/L and 5.2 gS/L rate.

Test results allow confirmation that SPGM catalyst shows significantly high catalyst performance and sulfur resistance.

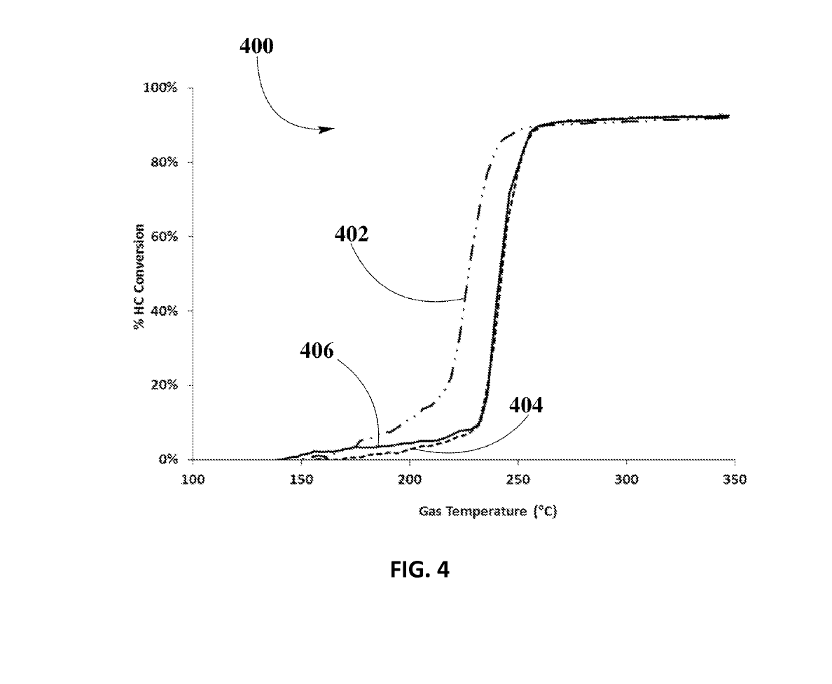

FIG. 4 shows HC conversion comparison 400 for SPGM catalyst samples tested according to DOC test methodology 200 and employing a standard gas stream composition under DOC LO test 210, isothermal soaking under DOC condition 220, and sulfated DOC condition for 2.6 gS/L and 5.2 gS/L, at about 340° C. and SV of about 54,000 h⁻¹, according to an embodiment.

As can be seen in FIG. 4, conversion curve 402 represent % THC (Total hydrocarbons) conversion LO before sulfation, under DOC LO test 210 and at isothermal soaking under DOC condition 220; conversion curve 404 depicts % THC conversion LO after sulfation under sulfated DOC condition 240 for about 12 hours, SO₂ concentration of about 2.6 gS/L; and conversion curve 406 shows % THC conversion after sulfation under sulfated DOC condition 240 for second period of about 12 hours (a total sulfation time of about 24 hours), with SO₂ concentration of about 5.2 gS/L.

It may be observed that before sulfation, THC oxidation in conversion curve 402 starts increasing rapidly as temperature increases, reaching a % THC conversion of about 88.4% at about 249° C., with a temperature of 50% THC conversion (T₅₀) of about 228° C. After sulfation, for conversion curve 404 and conversion curve 406, THC conversion decreased consistently, showing similar catalyst behavior activity for both sulfation conditions. As noted in conversion curve 404 and conversion curve 406, THC conversion for 2.6 gS/L and 5.2 gS/L is respectively high to about 88.4% at about 256° C. with a temperature of 50% THC conversion (T₅₀) of about 240° C.

Test results allow confirmation that the disclosed SPGM catalyst shows a highly significant performance in THC oxidation and high stability, and sulfur resistance.

Sulfur resistance of SPGM samples

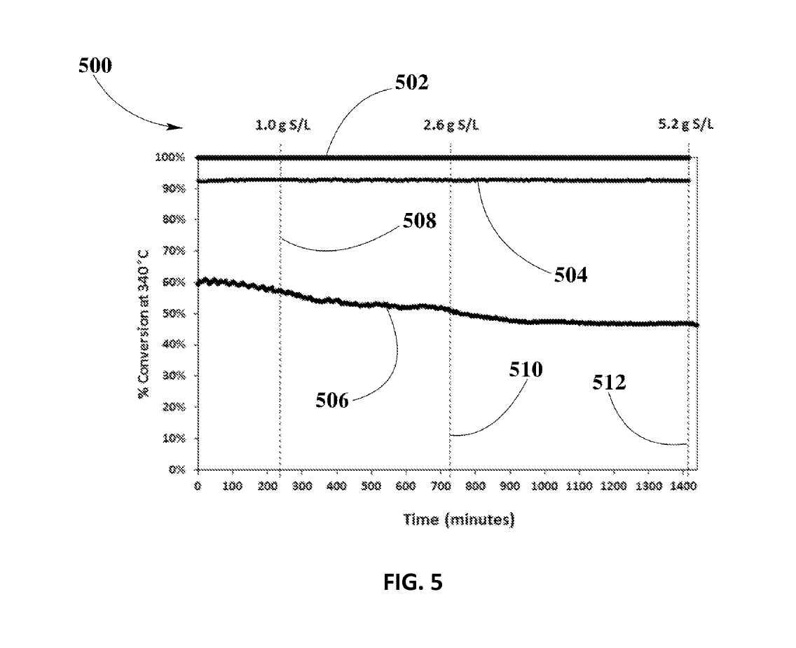

FIG. 5 represents sulfur resistance 500 for SPGM catalyst samples tested according to DOC test methodology 200, employing a standard DOC gas stream composition and 3 ppm SO2 at different time interval resulting in a total sulfur concentrations of 5.2 gS/L of substrate, at about 340° C. and SV of about 54,000 h⁻¹, according to an embodiment.

As can be seen in FIG. 5, conversion curve 502, conversion curve 504, and conversion curve 506 represent % CO conversion, %THC conversion, and % NO conversion at 340° C., respectively, for the entire protocol of DOC test methodology 200. Dotted lines 508, 510, 512, shows total sulfur concentrations in the DOC standard gas stream composition at different times during sulfation of disclosed SPGM catalyst sample. Line 508 shows sulfur resistance at 1.0 gS/L, after soaking under sulfated DOC condition for about 4 hours; line 510 depicts sulfur resistance at 2.6 gS/L, after soaking under sulfated DOC condition for about 12 hours; and line 512 shows sulfur resistance at 5.2 gS/L, after soaking under sulfated DOC condition for about 24 hours.

It may be observed in FIG. 5 that at about 340° C., disclosed SPGM catalyst shows properties of being a significant stable catalyst presenting high and stable levels of CO conversion and THC conversion. The levels of about 100.0% CO conversion and about 92.0% HC conversion point at highly desirable properties of selectivity and sulfur resistance for a catalyst in DOC applications. When NO conversion in conversion curve 506 is analyzed, it may be seen that during the long-term sulfation of SPGM catalyst samples at the plurality of sulfation periods and sulfur concentrations shown in FIG. 5, NO conversion is reduced from approximately about 60% to approximately 50% NO conversion after 5.2 gS/L, confirming that the disclosed SPGM catalyst may provide a significantly sulfur-resistant property desirable for DOC applications at the sulfation rate of 1.0 gS/Lit, 2.6 gS/Lit and 5.2 gS/Lit.

Comparison of NO oxidation and sulfur resistance of disclosed SPGM catalyst versus PGM catalyst

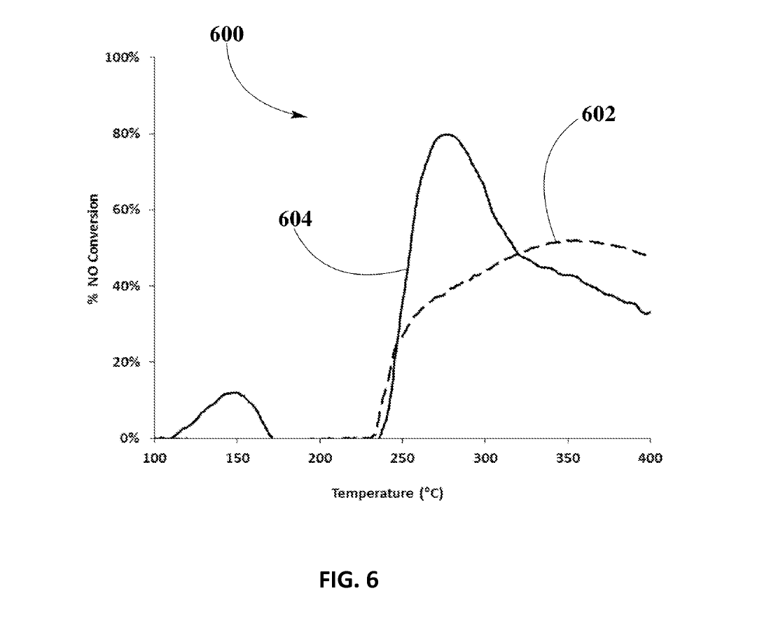

FIG. 6 shows NO conversion comparison 600 of disclosed SPGM catalyst sample versus an equivalent PGM catalyst, under DOC test methodology 200 and before sulfation, employing a standard gas stream composition under I standard DOC LO at SV of about 54,000 h⁻¹, according to an embodiment.

As can be seen in FIG. 6, Conversion curve 604 depicts % NO conversion for SPGM catalyst sample. Conversion curve 602 shows % NO conversion for a PGM catalyst with same material composition and preparation as the PGM catalyst in OC layer 104 for the disclosed SPGM catalyst. To prepare PGM control sample Al203-5%SiO₂ support oxide is milled into aqueous slurry and metallized by a solution of Pt and Pd nitrates with a loading about 4.5 g/ft³ of Pt and about 0.25 g/ft³ of Pd. Subsequently, WC layer is deposited onto substrate and calcined at about 550° C. for about 4 hours.

It may be observed that before sulfation, NO oxidation in conversion curve 602 for PGM catalyst reaches a % NO conversion of about 51.3% at about 340° C. NO oxidation in conversion curve 604 for SPGM catalyst reaches a % NO conversion of about 79.2% at about 275° C.

The difference between the disclosed SPGM catalyst and PGM control sample is the presence of ZPGM layer in SPGM catalyst. The synergistic effect between ZPGM material composition and PGM material composition leads to such improvement in NO oxidation observed for SPGM catalyst. This results verifies that the disclosed SPGM catalyst for DOC application have a significantly improved catalyst efficiency when compared to an equivalent PGM catalyst.

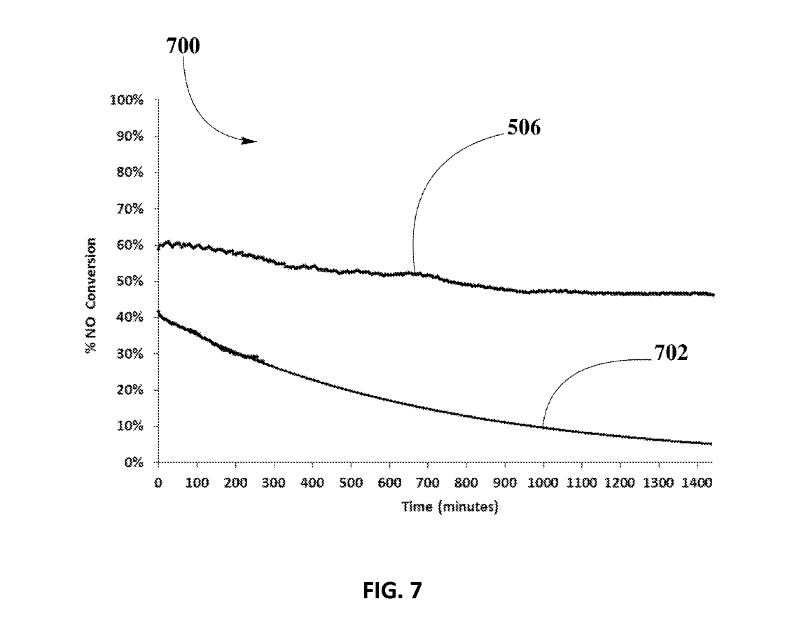

FIG. 7 depicts sulfur resistance comparison 700 for the disclosed SPGM catalyst versus an equivalent PGM catalyst, under isothermal sulfated DOC condition at sulfur concentration of 5.2 gS/L resulting from flowing about 3 ppm SO₂ for of about 24 hours, at about 340° C. and SV of about 54,000 h⁻¹, according to an embodiment.

As can be seen in FIG. 7, conversion curve 702 shows % NO conversion for PGM control catalyst sample and conversion curve 506 depicts % NO conversion for disclosed SPGM catalyst sample as described in FIG. 5.

The effect of long-term sulfation may be verified by the significant decrease in NO conversion of PGM control sample, indicating that after flowing 5.2 gS/Lit, the NO conversion decreased from approximately 42.0% to about 5%, as seen in conversion curve 702, which may confirm that the PGM catalyst control sample with low loading of PGM (about 5 g/ft³) does not appear to be resistant to sulfur.

As seen in conversion curve 506, for the long-term sulfation exposure of the disclosed SPGM catalyst sample after flowing 5.2 gS/L, the NO conversion presented a reduction from about 60% NO conversion to approximately about 50% in NO conversion, which indicates catalyst stability of the SPGM catalyst sample and significant sulfur resistance, which is improved by adding a WC layer of ZPGM including a YMnO₃ perovskite structure, as described in the present disclosure. The NO conversion of disclosed SPGM catalyst and PGM reference catalyst is approximately 50% and 5% after 5.2 gS/L exposure. The loading of PGM in both disclosed SPGM and PGM control sample is 5 g/ft³, however, the presence of ZPGM layer in SPGM catalyst significantly improved sulfur resistance, as well as NO oxidation efficiency of PGM catalyst.

The results achieved during testing of the SPGM catalyst samples in present disclosure may confirm that SPGM prepared to include a layer of low amount of PGM catalyst material added to a layer of ZPGM catalyst material may be capable of providing significant improvements in sulfur resistance of SPGM catalyst systems. As seen, although initial activity is the same, HC and CO conversions are shown to be significantly stable in case of SPGM catalysts after sulfation exposure.

The diesel oxidation property of disclosed SPGM catalyst system may provide an indication that under diesel conditions their chemical composition may be more efficient operationally-wise, and from a catalyst manufacturer's viewpoint, an essential advantage given the economic factors involved in using YMnO₃ perovskite as synergizing catalyst material to PGM by using very low amount of PGM material compositions.

While various aspects and embodiments have been disclosed, other aspects and embodiments may be contemplated. The various aspects and embodiments disclosed here are for purposes of illustration and are not intended to be limiting, with the true scope and spirit being indicated by the following claims.

What is claimed is:

1. A diesel oxidation catalyst (DOC) system comprising:
a 2-layer synergized platinum group metal (SPGM) catalyst comprising:
a) a washcoat layer comprising zero platinum group metal (ZPGM) catalyst, optionally on a first support oxide, and
b) an overcoat layer comprising a low loading platinum group metal (LLPGM) catalyst, optionally on a second support oxide.

2. The DOC system of claim 1, wherein the washcoat layer comprises a perovskite structure.

3. The DOC system of claim 1, wherein the washcoat layer is deposited on a substrate.

4. The DOC system of claim 2, wherein the perovskite comprises silver, manganese, yttrium, lanthanum, cerium, iron, praseodymium, neodymium, strontium, cadmium, cobalt, scandium, copper, or niobium.

5. The DOC system of claim 1, wherein the first or second support oxide independently comprises zirconia, niobium pent oxide, niobium-zirconia, alumina type support oxide, titanium dioxide, tin oxide, zeolite, silicon dioxide, or mixtures thereof.

6. The DOC system of claim 5, wherein the zirconia is doped.

7. The DOC system of claim 6, wherein the doped zirconia is doped with a lanthanide group metal.

8. The DOC system of claim 1, wherein the ZPGM catalyst comprises of YMnO₃ perovskite structure on a doped ZrO₂ support oxide.

9. The DOC system of claim 1, wherein the LLPGM catalyst comprises platinum and palladium on an alumina-silica support oxide.

10. The DOC system of claim 9, wherein the alumina-silica support oxide is Al₂O₃-5% SiO₂.

11. The DOC system of claim 1, wherein the LLPGM is about 5 g/ft³.

12. The DOC system of claim 11, wherein the about 5 g/ft³ is about 4.5 g/ft³ of platinum and about 0.25 g/ft³ of palladium.

13. The DOC system of claim 1, wherein the DOC has a sulfur resistance of about 5.2 gS/L.

14. The method of converting nitrogen oxides from diesel exhaust comprising applying a gas stream to a DOC system comprising a 2-layer synergized platinum group metal (SPGM) catalyst comprising:
a) a washcoat layer comprising zero platinum group metal (ZPGM) catalyst, optionally on a first support oxide, and
b) an overcoat layer comprising a low loading platinum group metal (LLPGM) catalyst, optionally on a second support oxide.

15. The method of claim 14, wherein nitrogen oxide conversion is about 50%.

16. The method of claim 4, wherein about 100% of carbon monoxide and about 92% of hydrocarbon is converted.

17. The DOC system of claim 14, wherein the washcoat layer comprises a perovskite structure.

18. The DOC system of claim 14, wherein the washcoat layer is deposited on a substrate.

19. The DOC system of claim 17, wherein the perovskite comprises silver, manganese, yttrium, lanthanum, cerium, iron, praseodymium, neodymium, strontium, cadmium, cobalt, scandium, copper, or niobium.

20. The DOC system of claim 14, wherein the first or second support oxide independently comprises zirconia, niobium pent oxide, niobium-zirconia, alumina type support oxide, titanium dioxide, tin oxide, zeolite, silicon dioxide, or mixtures thereof.

21. The DOC system of claim 20, wherein the zirconia is doped.

22. The DOC system of claim 21, wherein the doped zirconia is doped with a lanthanide group metal.

23. The DOC system of claim 14, wherein the ZPGM catalyst comprises of YMnO₃ perovskite structure on a doped ZrO₂ support oxide.

24. The DOC system of claim 14, wherein the LLPGM catalyst comprises platinum and palladium on an alumina-silica support oxide.

25. The DOC system of claim 24, wherein the alumina-silica support oxide is Al₂O₃-5% SiO₂.

26. The DOC system of claim 14, wherein the LLPGM is about 5 g/ft³.

27. The DOC system of claim 26, wherein the about 5 g/ft³ is about 4.5 g/ft³ of platinum and about 0.25 g/ft³ of palladium.

28. The DOC system of claim 14, wherein the DOC has a sulfur resistance of about 5.2 gS/L.
